(19) United States
(12) Patent Application Publication
(10) Pub. No.: US 2016/0005052 A1
(43) Pub. Date: Jan. 7, 2016

(54) INFORMATION PROCESSING SYSTEM AND INFORMATION PROCESSING METHOD

(71) Applicant: Hitachi, Ltd., Tokyo (JP)

(72) Inventors: Nobuo Sato, Tokyo (JP); Kazuo Yano, Tokyo (JP); Satomi Tsuji, Tokyo (JP)

(73) Assignee: Hitachi, Ltd., Tokyo (JP)

(21) Appl. No.: 14/417,585

(22) PCT Filed: Oct. 25, 2013
(86) PCT No.: PCT/JP2013/078894

§ 371 Date: Jan. 27, 2015

(51) Int. Cl. G06Q 30/02

(52) U.S. Cl. CPC G06Q 30/0201

(57) ABSTRACT

This invention provides an information processing technique making it easy to determine merchandise placement in a store.

This technique calculates probabilities that customers stay by each of plural shelves (AP), using first information (customers' behavior characteristics) relevant to a probability of customers staying over time after entering a store, second information (locations-related information) indicating shelf-to-shelf distances for plural shelves provided in the store, and third information indicating a staying time (DP6) during which customers stay in the store and a move interval (DP7) at which customers move from shelf to shelf, and simulation conditions as follows: a) customers start to move from a store entrance; b) there is a high probability that customers move to a shelf nearer to them than a distant shelf among the shelves; c) customers stay in the store only for a staying time; and d) customers randomly move from shelf to shelf.

### TECHNICAL FIELD

The present invention relates to an information processing system and an information processing method. More particularly, the invention relates to an information processing system and an information processing method for simulating how customers tend to move in a store.

### BACKGROUND ART

As background art in the present technical field, there are Patent Literatures 1 and 2.

Patent Literature 1 describes a technique that, based on information on movement of an object such as a car or a person having a positioning terminal (such as GPS), calculates time during which the object stays in each of locations and a probability of a location to where it will next move, thereby estimating a moving line of the object including a person not having a positioning terminal as well.

Patent Literature 2 describes a technique that causes an agent as a virtual human to walk in a scene created based on three-dimensional map information (with input values for size of the field of vision, height, and a route to walk), estimates percentages of locations that easily come in the human field of vision and locations that do not do so (natural watching behavior), and performs a crime prevention simulation by using the estimation results.

### CITATION LIST

### Patent Literature

Patent Literature 1: Japanese Unexamined Patent Application Publication No. 2013-210870
Patent Literature 1: Japanese Unexamined Patent Application Publication No. 2011-210006

### SUMMARY OF INVENTION

### Technical Problem

Merchandise placement in a store has so far been determined mostly depending on intuition and experience of store staffs. This is because there are complex factors for customers to make a buying decision, such as characteristics of merchandise items, customers' behavior characteristics (staying time, the number of items to buy, etc.), and locational characteristics (such as the position and height of a shelf) and it is thought that store staffs who most watch customers most understand these factors. That is, a possibility that a merchandise item M placed in coordinates P is purchased has a relationship that is expressed by equation (1) below, using f as a function, and merchandise placement in a store has so far been determined under the thought that store staffs most understand this.

“Possibility that a merchandise item M placed in coordinates P is purchased”=f(“Locational characteristic”,“Characteristic of the merchandise item”, and “Customers' behavior characteristics”) (1)

Now, obviously, such a method strongly depends on the ability of an individual store staff and it is not always possible to carry out appropriate merchandise placement with regard to a complex system comprised of multiple factors. Therefore, a technique for simplifying complex factors and making it easy to determine merchandise placement is hoped for. However, neither description nor suggestion of such a technique was found in any literature as well as in each of the above-mentioned Patent Literature.

In the light of the foregoing, an object of the present invention is to provide a technique making it easy to determine merchandise placement.

### Solution to Problem

To solve the above-noted problem, for example, a configuration described in claims is adopted. The present application includes a plurality of solutions to the above-noted problem and examples thereof are set forth below.

One aspect of the invention resides in an information processing system characterized by including an input unit that takes input of first information relevant to a probability of customers staying over time after entering a store, second information indicating shelf-to-shelf distances for a plurality of shelves provided in the store, and third information indicating a staying time during which customers stay in the store and a move interval at which customers move from shelf to shelf; a storage unit that stores the first information, second information, and third information, and simulation conditions as follows: a) customers start to move from a store entrance; b) there is a high probability that customers move to a shelf nearer to them than a distant shelf among the shelves;

c) customers stay in the store only for a staying time; and
d) customers randomly move from shelf to shelf; a simulator unit that calculates probabilities that customers stay by each of the shelves, using the first information, second information, third information, and the simulation conditions; and a display unit that displays the probabilities associated with the shelves.

Another aspect of the invention resides in an information processing method characterized by including a first step of receiving input of first information relevant to a probability of customers staying over time after entering a store, second information indicating shelf-to-shelf distances for a plurality of shelves provided in the store, and third information indicating a staying time during which customers stay in the store and a move interval at which customers move from shelf to shelf; a second step of calculating probabilities that customers stay by each of the shelves, using the first information, second information, third information, and simulation conditions as follows: a) customers start to move from a store entrance; b) there is a high probability that customers move to a shelf nearer to them than a distant shelf among the shelves; c) customers stay in the store only for a staying time; and d) customers randomly move from shelf to shelf; and a third step of displaying the probabilities associated with the shelves.

Another aspect of the invention resides in an information processing system characterized by including an input unit that takes input of shelves' coordinates information in a store, shelf numbers of the shelves, and information associating these sets of data; a storage unit that stores shelves' coordinates information, shelf numbers of the shelves, and information associating these sets of data; a simulator unit that executes cycles of a first process that calculates a staying position or staying probability of customers in the store at given time t and a second process that calculates a staying position or staying probability of customers at time (t+Δt), using the shelves' coordinates information, the shelf numbers of the shelves, and information associating these sets of data, thereby calculating a stop-by likelihood of the customers stopping by each of the shelves or a sales prediction for each of the shelves; and a display unit that displays the stop-by likelihood or the sales prediction.

### Advantageous Effects of Invention

According to the present invention, it would be made easy for a person in charge of merchandise placement to determine merchandise placement.

### BRIEF DESCRIPTION OF DRAWINGS

FIG. 1 is a diagram depicting a structural example and a use scene example of a customer simulator system pertaining to an embodiment of the present invention.

FIG. 2A is a block diagram illustrating a configuration of an application server.

FIG. 2B is a block diagram illustrating a configuration of a client.

FIG. 3 is a diagram illustrating the flow of a stop-by simulation which is executed in an embodiment of the present invention.

FIG. 4 is a diagram illustrating the flow of a store layout evaluation which is executed in an embodiment of the present invention.

FIG. 5 is a sequence diagram illustrating a flow which is executed in an embodiment of the present invention.

FIG. 6 is a diagram depicting an example of a content which is generated in an embodiment of the present invention.

FIG. 7 is a diagram depicting an example of a content which is generated in an embodiment of the present invention.

FIG. 8 is a diagram depicting an example of a content which is generated in an embodiment of the present invention.

FIG. 9 is a diagram depicting an example of a content which is generated in an embodiment of the present invention.

FIG. 10 is a diagram illustrating the flow of a calculation for interchanging merchandise shelves, which is executed in an embodiment of the present invention.

FIG. 11 is a diagram illustrating the flow of store layout evaluation learning which is executed in an embodiment of the present invention.

FIG. 12 is a diagram presenting an example of the contents of a parameter table which is stored in a simulation database.

FIG. 13 is a diagram presenting an example of the contents of a state transition probability matrix table which is stored in the simulation database.

FIG. 14 is a diagram presenting an example of the contents of a table of probability by hopping which is stored in the simulation database.

FIG. 15 is a diagram presenting an example of the contents of a stop-by rate S table which is stored in the simulation database.

FIG. 16 is a diagram presenting an example of the contents of a location bias table which is stored in the simulation database.

FIG. 17 is a diagram presenting an example of the contents of a merchandise effect table which is stored in the simulation database.

FIG. 18 is a diagram presenting an example of the contents of a POS table which is stored in a sales database.

FIG. 19 is a diagram presenting an example of the contents of a sales table which is stored in the sales database.

FIG. 20 is a diagram presenting an example of the contents of a shelf and merchandise table which is stored in a shelves database.

FIG. 21 is a diagram presenting an example of the contents of a shelf-to-shelf distance table which is stored in the shelves database.

FIG. 22 is a diagram presenting an example of the contents of a map table which is stored in a map database.

FIG. 23 is a diagram presenting an example of the contents of a stop-by rate table which is stored in a stop-by database.

FIG. 24 is a diagram presenting an example of the contents of a charging table which is stored in a charging database.

### DESCRIPTION OF EMBODIMENTS

### First Embodiment

To begin with, an overview of the present invention is described. As noted previously, as the factors to determine a possibility that a merchandise item M placed in coordinates P is purchased, there are a locational characteristic, a characteristic of the merchandise item, and customers' behavior characteristics. Here, the present inventors directed attention to, particularly, a locational characteristic among the above factors.

The reason for this is that the characteristics of merchandise items vary largely over time under the influence of a season, area, fashion, etc., whereas locational characteristics less vary over time because they are determined depending on a storefront design, an operation conducted by a store, and others. Hence, once values are calculated in terms of locational characteristics, these values can be used over a long term; this is especially beneficial.

Then, the present inventors figured out a simulation technique for modifying equation (1) provided previously to equation (2) below, using g as a function.

“Possibility that a merchandise item M placed in coordinates P is purchased”=“Locational characteristic”*g(“Characteristic of the merchandise item) (2)

A method for modifying equation (1) provided previously to equation (2) is to quantify customers' behavior characteristics based on customers' moving route information and simulate and calculate a locational characteristic as a quantitative value. If such a modification can be made, it would become possible for a person who determines merchandise placement to consider only a locational characteristic factor and only a merchandise item's characteristic factor separately and it would be made easier to determine merchandise placement.

In the light of the foregoing, a customer simulator system pertaining to an embodiment of the present invention is outlined. The customer simulator system pertaining to the present embodiment operates as a customer simulator with input information as follows: store layout information including merchandise shelves arrangement, passages, and doorways and store characteristics including relationships between merchandise items by POS, customers' moving distance, and customers' staying time. A store layout evaluation content and a content for optimizing merchandise shelves arrangement are included in the simulator.

These contents use simulation results of the customer simulator. This customer simulator performs a simulation based on conditions as follows: a) customers start to move from a store entrance; b) there is a high probability that customers move to a shelf nearer to them than a distant shelf among a plurality of shelves; c) customers stay in the store only for a staying time; and d) customers randomly move from shelf to shelf. By this simulation, the customer simulator quantifies customers' behavior characteristics based on customers' moving route information and simulates and calculates a locational characteristic as a quantitative value. Based on this simulation, the store layout evaluation content is to predict customers' moving lines and stop-by likelihood with the exclusion of merchandise's influence, and enables the prediction of customer stop-by likelihood according to each layout plan, for example, when opening a new store or changing a store layout. Then, the content for optimizing merchandise shelves arrangement enables the prediction of even an increase/decrease in sales per customer, customer purchases count, and customer purchased items count due to, for example, changing shelves arrangement in addition to customer stop-by likelihood.

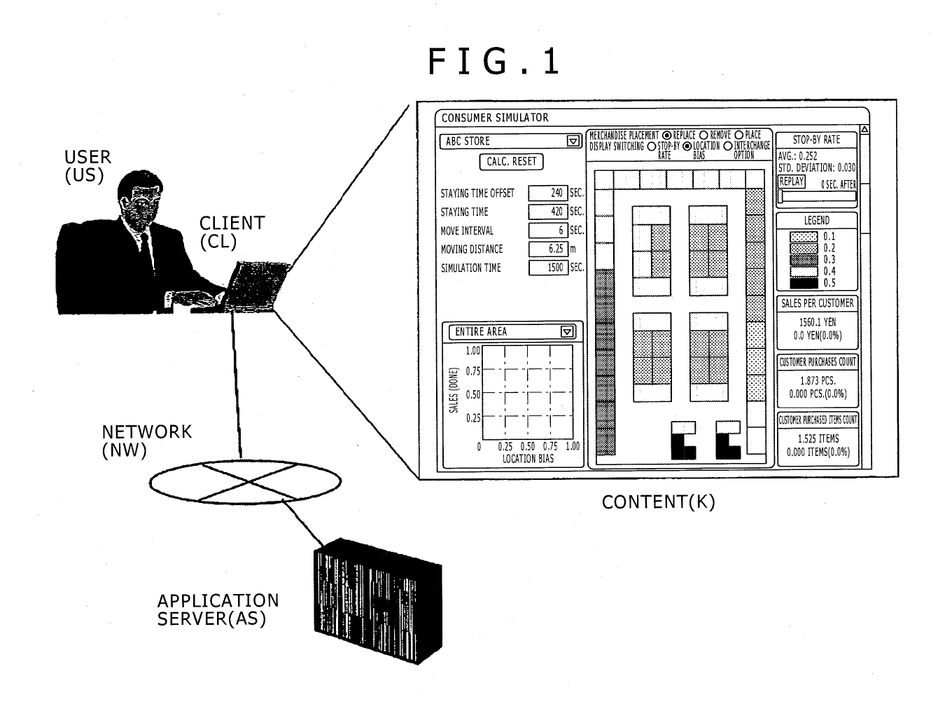

FIG. 1 depicts an outline of a system of a first embodiment. In the first embodiment, by operating a client (CL), a user (US) can view a content (K). The client (CL) is connected to a network (NW) and a request is transmitted from the user (US) via the client (CL) to an application server (AS). The application server (AS) performs processing according to a request of the user (US) and transmits results to the client (CL). The client (CL) generates a screen using the received results and displays them in the content (K) on a display (CLID).

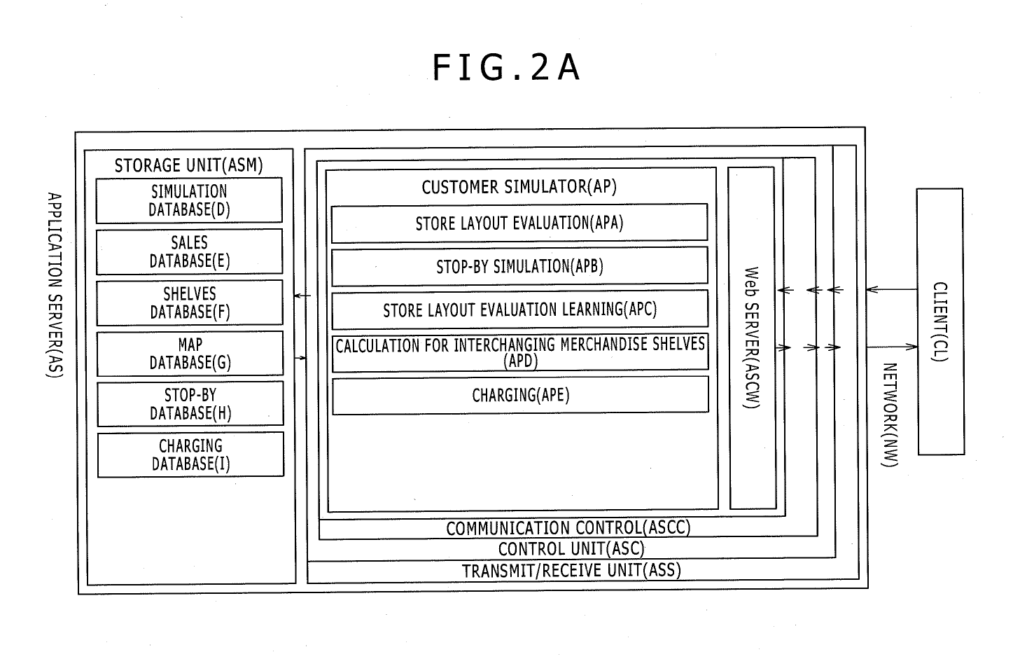

FIGS. 2A and 2B are explanatory diagrams depicting components of a customer simulator system which is one embodiment. Although separate diagrams are provided for convenience of depiction, the processes depicted in each diagram are executed in cooperation with one another.

FIGS. 2A and 2B depict a series of flow in which the application server (AS) performs processes in the customer client system until the client (CL) outputs a screen from results of analysis to the viewer.

The present system is comprised of the application server (AS) and the client (CL). Each of them has a general computer configuration including a processing unit, a storage unit, a network interface, etc.

The application server (AS) depicted in FIG. 2A performs processes of the customer simulator. When the application server (AS) has received a request from the client (CL) depicted in FIG. 2B, an application is activated automatically at a setup point of time or manually. Results of analysis made by the application server (AS) are transmitted to the client (CL) depicted in FIG. 25 through the network (NW).

The application server (AS) includes a transmit/receive unit (ASS), a storage unit (ASM), and a control unit (ASC).

The transmit/receive unit (ASS) performs data transmission and reception to/from the client (CL) depicted in FIG. 2B. In particular, the transmit/receive unit (ASS) receives a command transmitted from the client (CL) and, after the control unit (ASC) executes a customer moving around simulation, transmits results of analysis to the client (CL).

The storage unit (ASM) is comprised of a hard disk and a memory or an eternal recording device such as an SD card. The storage unit (ASM) stores databases for simulation execution, setup conditions, and results. In particular, the storage unit (ASM) stores a simulation database (D), a sales database (E), a shelves database (F), a map database (G), a stop-by database (H), and a charging database (I).

The simulation database (D) is a database storing parameters required for executing a simulation and output results. The sale database (E) is a database storing data relevant to purchases such as POS data. The shelves database (F) is a database storing data relevant to shelves. The map database (G) is a database storing data relevant to a map for an arrangement of shelves and the like. The stop-by database (H) is a database storing data relevant to a customer's action of stopping by a merchandise item or shelf. The charging database (I) is a database storing data relevant to charging a user (US) for using the customer simulator.

The control unit (ASC) includes a central processing unit (CPU) (omitted from depiction), exerts control of data transmission and reception, and executes a simulation. In particular, the CPU (omitted from depiction) executes a program which has been pre-registered in the control unit (ASC). A communication control (ASCC) controls timing of wired or wireless communication with the client (CL). Further, the communication control (ASCC) performs data format conversion and distribution of data to destinations according to data type.

A customer simulator (AP) is a process that selects necessary data from among data registered in the storage unit (ASM) and executes a simulation, according to a request from the client (CL). The customer simulator (AP) is comprised of the following components: store layout evaluation (APA), stop-by simulation (APB), store layout evaluation learning (APC), calculation for interchanging merchandise shelves (APD), and charging (APE).

The store layout evaluation (APA) is a process that executes a layout evaluation in terms of separate factors of location's effect and merchandise's effect from setup shelves arrangement and merchandise items. The stop-by simulation (APB) is a process that calculates a stop-by rate through simulation from setup shelves arrangement. The store layout evaluation learning (APC) is a process that learns shelves arrangement and stop-by rates based on an actual survey and parameters relevant to stop-by according to the type of business. The calculation for interchanging merchandise shelves (APD) is a process that predicts sales by selecting certain shelves and merchandise items through the use of the store layout evaluation (APA). The charging (APE) is a process that charges a user (US) for using the customer simulator.

A Web server (ASCW) performs processing to control an access 10 from the client (CL). The client (CL) obtains setup information via the Web server (ASCW). Results of simulation executed by the customer simulator (AP) are transmitted to the client (CL) via the Web server (ASCW).

Results of analysis once stored in the simulation database (D) are transmitted to the client (CL) depicted in FIG. 2B through the transmit/receive unit (ASSR).

The client (CL) depicted in FIG. 2B interfaces with the user and performs data input and output. The client (CL) includes an input/output unit (CLI), a transmit/receive unit (CLS), a storage unit (CLM), and a control unit (CLC).

The input/output unit (CLI) is a part that interfaces with the user. The input/output unit (CLI) includes a display (CLD), a keyboard (CLIK), and a mouse (CLIM) or the like. Another input/output device can be connected to an external input/output (CLIU), as necessary.

The display (CLID) is an image display device such as CRT (Cathode Ray Tube) or a liquid crystal display. The display (CLID) may include a printer or the like.

The transmit/receive unit (CLS) performs data transmission and reception to/from the application server (AS) depicted in FIG. 2A. In particular, the transmit/receive unit (CLS) transmits analysis conditions information (CLMP) to the application server (AS) and receives results of analysis.

The storage unit (CLM) is comprised of a hard disk and a memory or an eternal recording device such as an SD card. The storage unit (CLM) records information required for analysis and drawing, such as analysis conditions information (CLMP) and drawing setup information (CLMT).

As the analysis conditions information (CLMP), conditions such as the number of members to be analyzed and an analysis method selected, which have been specified by the user, are recorded.

As the drawing setup information (CLMT), information relevant to a draw position, i.e., as to what should be plotted in which part of a drawing is recorded. Further, the storage unit (CLM) may store a program which is executed by a CPU (omitted from depiction) in the control unit (CLC).

The control unit (CLC) includes the CPU (omitted from depiction) and performs the following: control of communication, input of analysis conditions from the client user (US), drawing or the like for presenting results of analysis to the client user (US). In particular, by executing a program stored in the storage unit (CLM), the CPU executes processes as follows: communication control (CLCC), Web browser (CLCW), analysis setup (CLCT), drawing setup (CLCP), and content generation (CLCA).

The communication control (CLCC) controls timing of wired or wireless communication with the application server (AS). Further, the communication control (CLCC) performs data format conversion and distribution of data to destinations according to data type.

The Web browser (CLOW) interfaces with the user (US), performs setup of analysis conditions information (CLMP) and drawing setup information (CLMT), and displays results which have been output by the content generation (CLCA) from results of analysis at the application server (AS) on the Web browser (CLOW).

The analysis condition (CLCT) receives analysis conditions specified by the user via the input/output unit (CLI) and stores them as the analysis conditions information (CLMP) into the storage unit (CLM). Here, a category such as case and date of data that is used for analysis, parameters for analysis, etc. are set up. The client (CL) transmits these settings to the application server (AS) along with an analysis request and, concurrently, executes drawing setup (CLCP).

The drawing setup (CLCP) calculates a method of displaying results of analysis based on drawing setup information (CLCM) and positions to plot a drawing. Results of this process are recorded as drawing setup information (CLMT) into the storage unit (CLM).

The content generation (CLCA) generates a display screen to display results of analysis obtained from the application server (AS) based on a form described in the drawing setup information (CLMT); for example, content (K) in FIG. 1 in the drawing setup information (CLMT). Created display results are presented to the user through the Web browser (CLCW) and via the output device such as the display (CLOD).

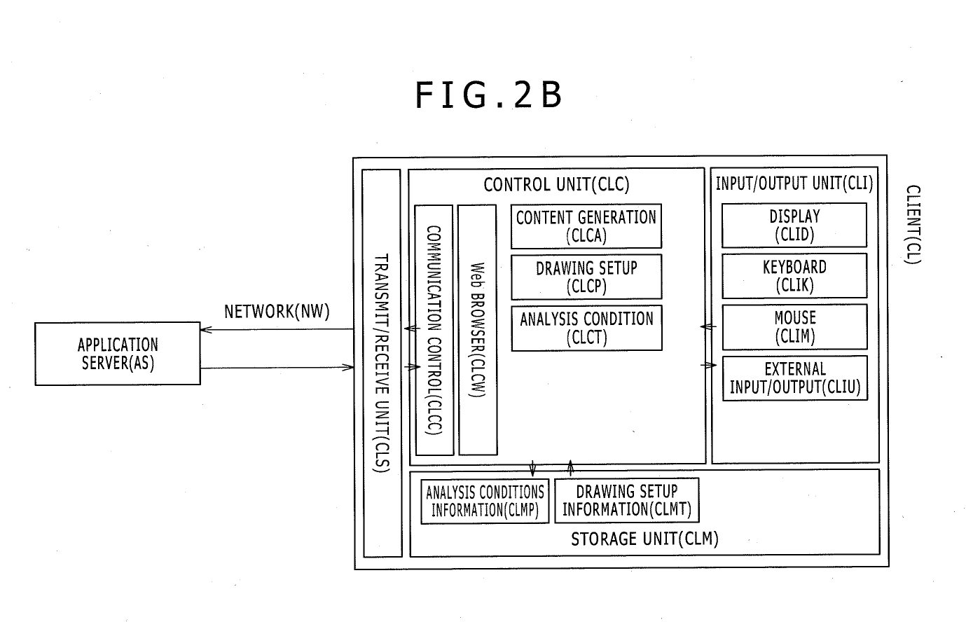

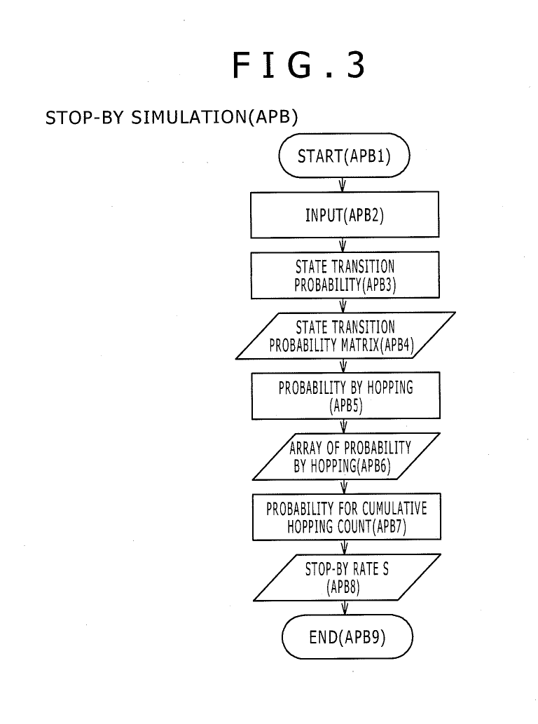

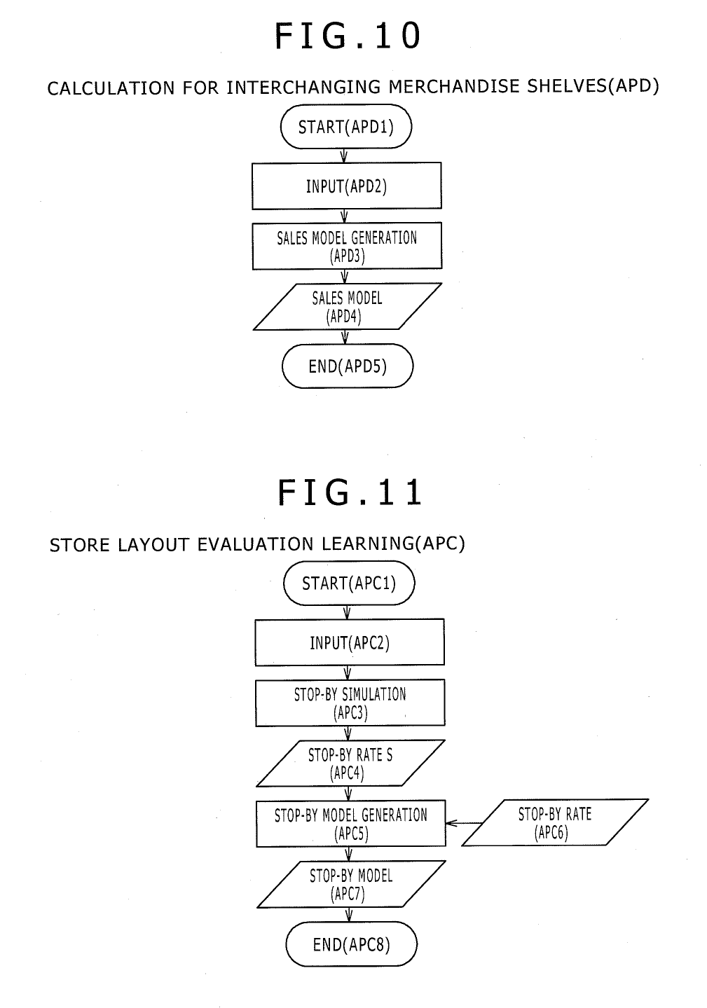

FIG. 3 is a flowchart of a stop-by simulation (APB) process of the customer simulator (AP). This process calculates a stop-by rate S (a probability that customers stay by each of the shelves in a store) which is an element for calculating a location bias representing a locational characteristic. While this process is a part of a store layout evaluation (APA) process flow which will be described with FIG. 4, this process is described here in advance, because it is used commonly also in a store layout evaluation learning (APC) process which will be described with FIG. 11.

In the process described below, a stop-by rate is calculated through simulation on the assumption that a shelf having a high stop-by rate is the one in a location where customers are likely to stop by it.

Upon the start (APB1), the process reads in input files necessary for input (APB2). Necessary input files are those having information relevant to locations (the arrangement of shelves, places where doorways are, etc.) and information relevant to customers' behavior characteristics.

First, the information relevant to locations is information indicating shelf-to-shelf distances for a plurality of shelves provided in a store, usually known from store layout information or the like.

Next, the information relevant to customers' behavior characteristics is information that is obtained by measuring a customer's moving route (information that is used to relate shelf position versus time) using a video camera or various sensors such as a wearable sensor; i.e., information relevant to a probability of customers staying over time after entering the store.

By the way, before developing the present invention, the present inventors performed a practical experiment regarding in-store customers' behavior characteristics and found that a probability that a customer in the front of one shelf will move to another shelf (hereinafter referred to as “hopping”) is lower, the longer the distance between these two shelves (if there is a blockade between the selves, an effective distance taking account of a bypass distance). Here, customers' behavior characteristics thus measured are plotted in a graph with the abscissa of shelf-to-shelf moving distance measure (longer toward right of the graph) and the ordinate of the number of customers who moved each of distance scales. It was found that this graph exhibits a behavior that can be approximated by a straight line, when taking the ordinate of the graph as a logarithmic axis according to a so-called exponential distribution. Hence, if the gradient and intercept of the exponential distribution are found, it is found that customers' behavior characteristics are uniquely determined. Therefore, customers' behavior can be quantified with two values of the gradient and intercept of the distribution. This intercept determines a staying time offset of customers (time during which most of customers uniformly stay in a store) and the gradient determines staying time (the staying probability becomes 1/e per this time). In this way, customers' behavior is quantified with the staying time offset and the staying time. Now, it is, of course, likely that the characteristic of a merchandise item has an influence on customers' behavior; for instance, a particular merchandise item which attracts popularity causes an extreme increase in the frequency that customers stop by a certain location. But, the inventors obtained the foregoing knowledge with the exclusion of merchandise's influence, because we thoroughly direct attention only to a probabilistic characteristic of customers' behavior.

Now, let us return to the flowchart of the stop-by simulation (APB) process. In a step of input (APB2), the process reads in data, from a parameter table (DP), stored under the appropriate case ID (DP1) for which the process should read in input files necessary for stand-by simulation (APB); it reads in the following data: staying time offset (DP5), staying time (DP6), move period (DP7), moving distance (DP9), and simulation time (DP9). It also reads in a shelf-to-shelf distance table (FD) from the shelves database (F). Detail on each of these tables will be described later (Likewise, detail on each table will be described later).

In a step of state transition probability (APB3), the process calculates a stop-by likelihood of customers stopping by the shelf. Here, customers are assumed to randomly move whenever hopping from one shelf to another. Calculating a state transition probability is comprised of two steps.

### Step 1: Calculating a State Transition

tr(i,j)=exp(−dd(i,j)/beta)

where tr (i, j) is a state transition probability, dd (i, j) is a shelf-to-shelf distance table (FD), and beta is a moving distance (DP8).

### Step 2: Normalizing the Result

The equation for calculating a state transition probability (APB3) is exemplary and other calculus equations may be used.

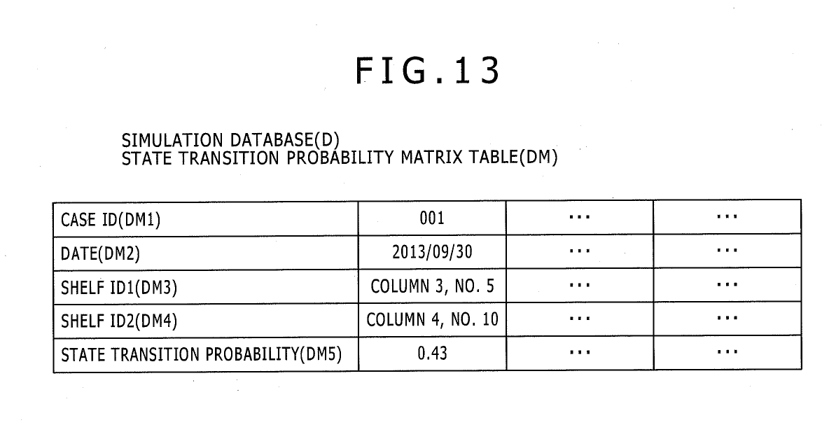

A state transition probability matrix (APB4) is a result output by calculating a state transition probability (APB3). Its detail will be described with FIG. 13.

A probability by hopping (APB5) is calculating a probability that customers go to the shelf at each hopping with regard to each shelf. Its calculus is comprised of four steps.

Step 1: Fixing Initial Conditions

Here, an entrance is weighted. This represents customers' behavior of being at an entrance at the start to simulation. In particular, an entrance and shelves by which customers are likely to stop at first are weighted by icon type (GM7) in a map table (GM) in the map database (G). This is expressed by the following equation.

pm(j,t)=1

where pm (j, t) is a table of probability by hopping and 1 is a hopping count of 1, that is, start. Even if the store has a plurality of entrances, the respective entrances may be weighted by 1, because this influence is absorbed by normalization.

Step 2: Determining a Probability that Customers go to Shelf j at a Hopping Count of k

pm(j,k)=pm(i,k−1)*tr(i,j)

where tr (i, j) is a state transition probability and pm (j, k) is a table of probability by hopping.

Step 3: Fixing a Duration Parameter

Here, if duration is smaller than the time specified for staying time offset (DP5), a coefficient of 1 is assigned. If duration is larger, a coefficient is assigned as: coefficient=exp (−total hopping count/staying time). Then, a modification is made as: pm (j, k)=pm (j, k)*coefficient.

Step 4: repeating steps 2 and 3 up to the total hopping count

The equations for calculating a probability by hopping (APB5) are exemplary and other calculus equations may be used.

Through the foregoing operations, the process calculates a probability that customers move from a position at count t (t is a natural number) to a position at count (t+1).

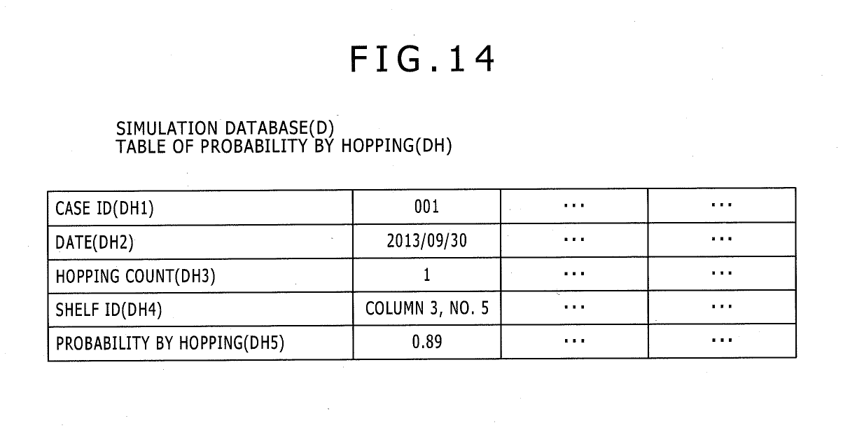

An array of probability by hopping (APB6) is a result output by calculating a probability by hopping (APB5). Its detail will be described with FIG. 14.

A probability for cumulative hopping count (APB7) is calculating a probability that customers go to shelf j until a cumulative hopping count. Its calculus is comprised of four steps.

Step 1: assigning 0 as an initial condition

Step 2: calculating a probability that customers go to shelf j up to a hopping count of k

cc(j,k)=cc(j,k−1)+(1−cc(j,k−1))*pm(j,k)

where cc (i, k) is a probability for cumulative hopping count. This means that (a probability that customers stop by shelf j up to a hopping count of k−1)+(a probability that customers do not stop by shelf j up to a hopping count of k−1)*(a probability that customers stop by shelf j at a hopping count of k).

Step 3: repeating step 2 up to the total hopping count

Step 4: outputting a value of cc at the total hopping count as a stop-by rate S (APB8).

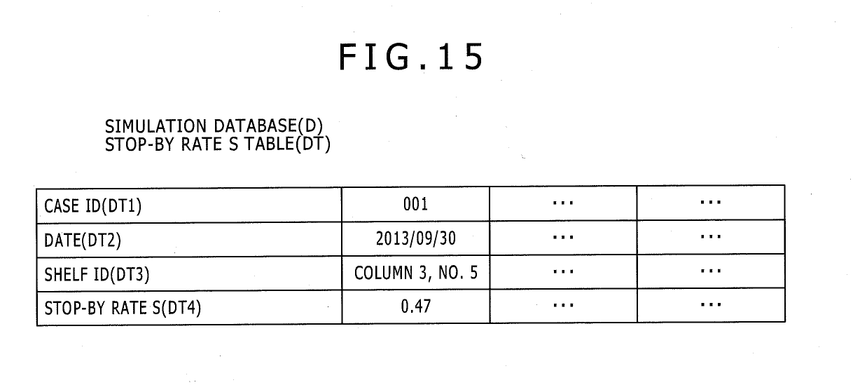

The stop-by rate S (APB8) is a result output by calculating a probability for cumulative hopping count (APB7). Its detail will be described with FIG. 15.

Additionally, a diagram of a network among merchandise items may be created from correlations among the merchandise items sold per day from a POS table (EP) and a coefficient obtained from this network may be included in the stop-by simulation (APB). A node in the network denotes a merchandise item and an edge denotes a relationship. By incorporating this network, a model is created in which the frequency of move differs depending on whether a distance between merchandise items is short or long in the network.

FIG. 4 is a flowchart of a store layout evaluation (APA) process of the customer simulator (AP).

In a step of input (APA2), the process reads in input files necessary for store layout evaluation (APA). The input files are, in particular, data stored under a desired case ID (DP, FD1) in the parameter table (DP) and the shelf-to-shelf distance table (FD).

In a step of stop-by simulation (APA3), the process executes the simulation described with FIG. 3 using the data obtained in the input (APA2) step. A stop-by rate S (APA4) is an output result of the stop-by simulation (APA3).

A location bias calculation (APA5) calculates a location's effect using the stop-by rate S (APA4) and a stop-by model (APA6) obtained by a store layout evaluation learning (APC) process which is described with FIG. 11. The stop-by model (APA6) is the same as a stop-by model (DP10) in the parameter table (DP).

A calculus equation for location bias calculation is as follows:

location bias=1/(1+exp(−1*(stop-by rate S)*gradient+intercept).

This is exemplary and other calculus equations may be used.

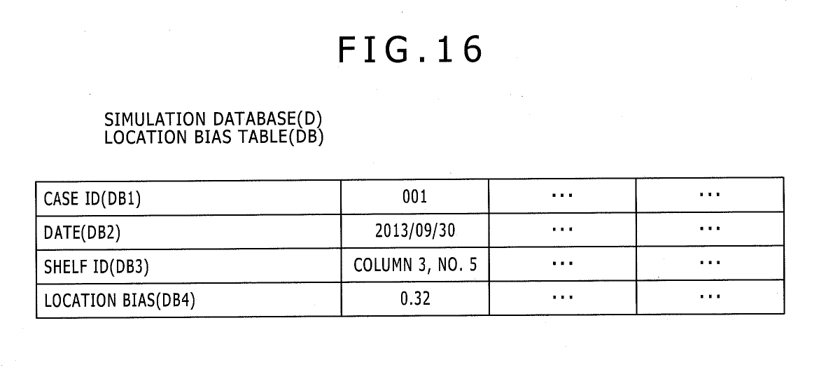

A location bias (APA7) is an output result of the location bias calculation (APA5). Its detail is presented in FIG. 16.

A bias calculation (APA8) calculates a merchandize group's effect (hereinafter referred to as “merchandise effect”) with the exclusion of the location's effect from sales (APA9). Inputs to the bias calculation (APA8) are the location bias (APA7) and the sales (APA9). The sales (APA9) are similar to a sales table (EU) in the sales database (E).

A calculus equation for the bias calculation (APA8) is as follows: sales=location bias*merchandise effect. This is exemplary and other calculus equations may be used. Merchandise effect (APA10) is an output result of the bias calculation (APA8) and represents the merchandize group's effect with the exclusion of the location's effect.

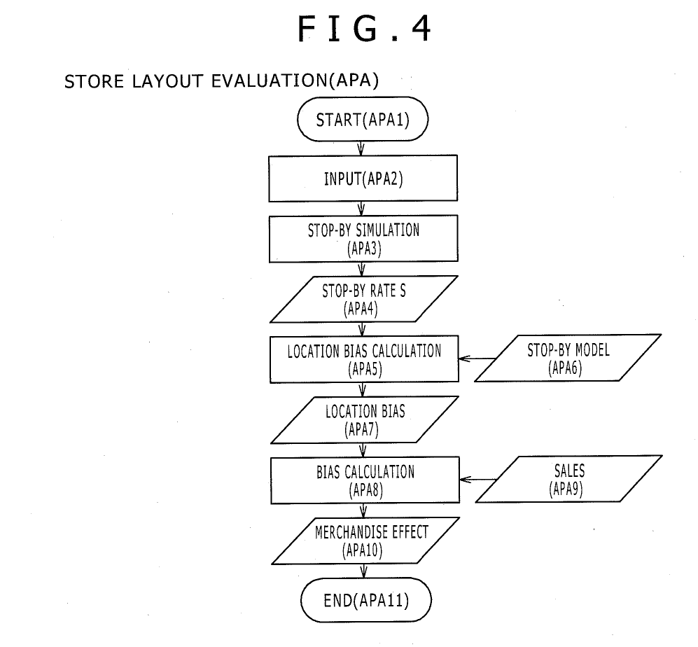

FIG. 5 is a sequence diagram regarding a store layout evaluation content using the customer simulator. FIG. 5 is comprised of the client (CL), the application server (AP), and a database manager (APM) in the application server (AP). Vertical arrow lines denote the progress sequence of operations in time series. Horizontal arrow lines indicate a relationship between components.

First, in a server activation (AP1) operation, the application server (AP) is activated to put the server ready to accept access from the client (CL). Application activation (CL1) means that the user (US) has activated the store layout evaluation content. A conditions input (CL2) operation performs setup of conditions for executing the customer simulator. This setup is executed by the analysis condition (CLCT) of the client (CL) and recorded into the analysis conditions information (CLMP). For calculation execution (CL3), the client requests the application server (AP) to start up the store layout evaluation content.

Then, in response to charging information sending (AP2) from the application server (AP), the database manager updates the charging table (IK) in the charging database (I). If the user is charged based on a click count (IK4), the database manager increments the click count by 1 in the appropriate entry in the charging table (IK). If the user is charged based on cloud usage time (IK5), the database manager records the starting time. This is an update (I1) operation. At the end of this process, the database manager stops to count the click count (IK4) or calculates usage time from the starting time and the ending time and adds the result to the value of cloud usage time (IK5) as usage time.

Then, in response to conditions sending (AP3) from the application server (AP), the database manager refers to the parameter table (DP) in the simulation database (D) based on the analysis conditions information (CLMP) and obtains data necessary for analysis from the simulation database (D), shelves database (F), and sales database (E) in the storage unit (ASM). This is conditions data retrieval (DFE1). In sending (DFE2), the database manager sends the thus obtained data to the application server (AP).

In a store layout evaluation (APA) operation, the server executes the store layout evaluation (APA) process illustrated in FIG. 4. In a content generation (CLCA) operation, the client generates a screen to display results of the store layout evaluation (APA) transmitted to the client (CL), using the drawing setup (CLOP). End (CL5) is the termination of the store layout evaluation content.

The foregoing description is summarized below. A customer simulation system pertaining to the present embodiment is characterized by including an input unit (a transmit/receive unit ASS) that takes input of first information (customers' behavior characteristics) relevant to a probability of customers staying over time after entering a store, second information (locations-related information) indicating shelf-to-shelf distances for a plurality of shelves provided in the store, and third information indicating a staying time (DP6) during which customers stay in the store and a move interval (DP7) at which customers move from shelf to shelf, a storage unit that stores the first information, second information, and third information, and simulation conditions as follows: a) customers start to move from a store entrance; b) there is a high probability that customers move to a shelf nearer to them than a distant shelf among the shelves; c) customers stay in the store only for a staying time; and d) customers randomly move from shelf to shelf, a simulator unit (a customer simulator AP) that calculates probabilities that customers stay by each of the shelves, using the first information, second information, third information, and simulation conditions, and a display unit (a display CLID) that displays the probabilities associated with the shelves.

Or an information processing method is provided, characterized by including a step (conditions input CL2) of receiving input of first information relevant to a probability of customers staying over time after entering a store, second information indicating shelf-to-shelf distances for a plurality of shelves provided in the store, and third information indicating a staying time during which customers stay in the store and a move interval at which customers move from shelf to shelf, a step (calculation execution CL3) of calculating probabilities that customers stay by each of the shelves, using the first information, second information, and third information, and simulation conditions as follows: a) customers start to move from a store entrance; b) there is a high probability that customers move to a shelf nearer to them than a distant shelf among a plurality of shelves; c) customers stay in the store only for a staying time; and d) customers randomly move from shelf to shelf, and a step (content generation CLCA) of displaying the probabilities associated with the shelves.

Owing to the foregoing features, an information processing system and an information processing method pertaining to the present invention are capable of separating sales into the factors of a location bias which is a locational characteristic and a merchandise effect which is a merchandise item's characteristic. This makes it possible for a person in charge of layout to consider only the locational characteristic factor and only the merchandise item's characteristic factor separately when determining merchandise placement. Therefore, it would become feasible to determine merchandise placement with a higher accuracy, not depending on the ability of an individual person in charge of layout. Moreover, various applications which will be described later can be implemented.

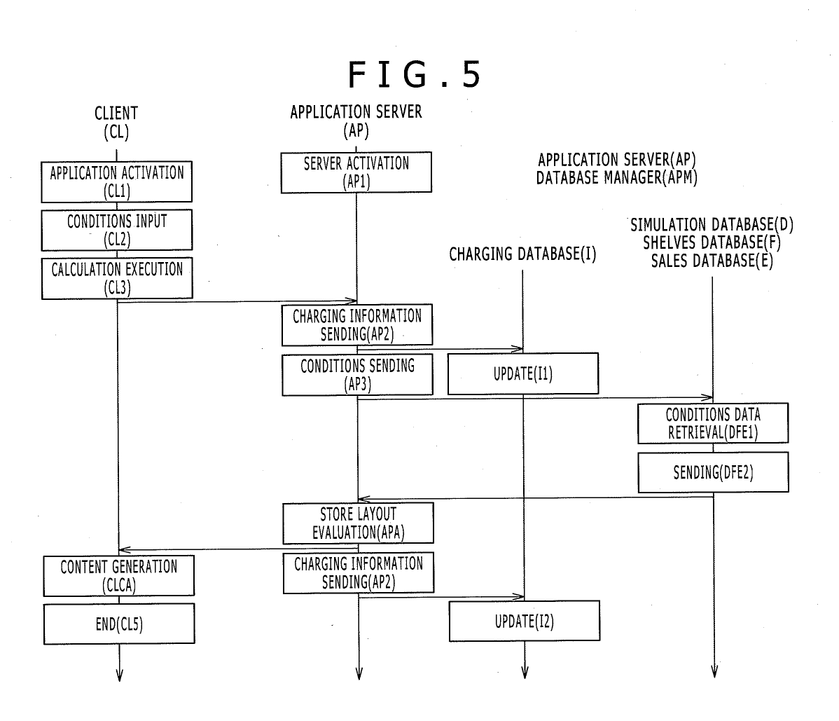

FIG. 6 is a screen of the store layout evaluation content (KA). KA1 is a store name (DP2) field. KA2 is a button to start executing calculation of the store layout evaluation content. This button works the same as calculation execution (CL3) in the sequence diagram of FIG. 5. KA3 points at parameters from the parameter table in the simulation database (D). KA4 is a graph showing a scatter diagram of location bias versus merchandise effect. KA5 is a setting area to edit a shelves layout. KA6 is a shelves layout area. KA7 is an area to display a stop-by rate which is a result of the store layout evaluation simulation. KA8 is a legend for the shelves layout. KA9 is an area to display sales per customer which is a result of a shelves layout evaluation simulation. KA10 is an area to display a customer purchases count which is a result of the shelves layout evaluation simulation. KA11 is an area to display a customer purchased items count which is a result of the shelves layout evaluation simulation.

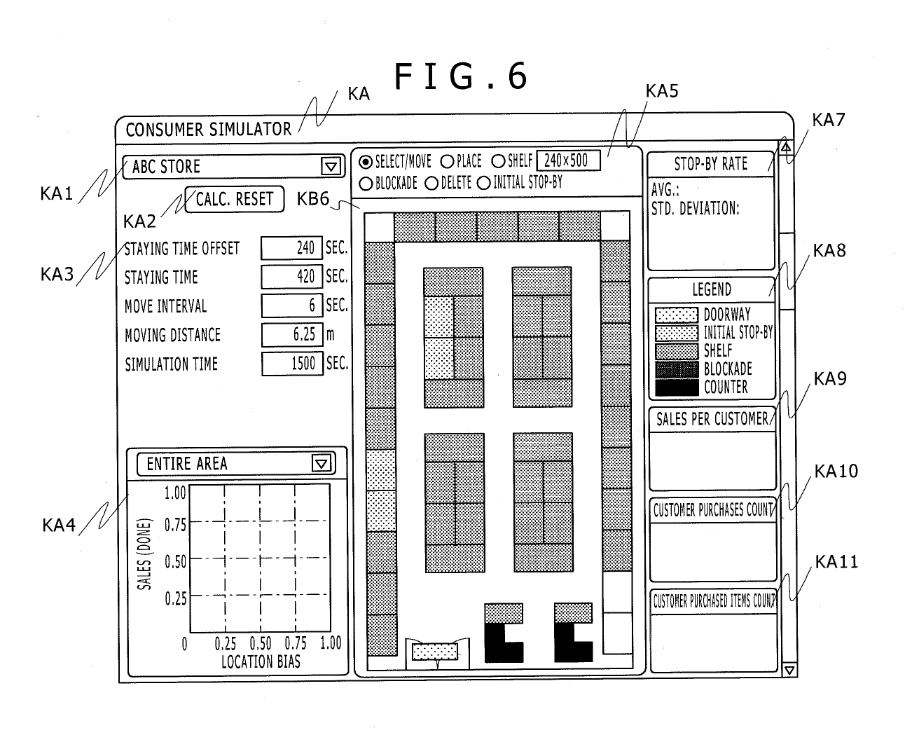

FIG. 6 is the screen at startup and the user may determine merchandise placement on the shelves using the areas KA5 and KA6. Then, KB in FIG. 7 is a result of the calculation executed by calculation execution (CL3). The screen of FIG. 7 displays a result of location bias that means a locational characteristic. In an area KB6, color density of colored shelves in the shelves layout indicates how large their location bias is. Darker shelves have larger values of location bias; i.e., KB61<KB62<KB63. Values corresponding to several tones are displayed in a legend KB8. By a configuration presenting a depiction in which the shelves are colored in the tones corresponding to their location bias values to represent location bias only as in FIG. 7, it would become easier that a person in charge of determining merchandise placement intuitively understands an influence of location's effect on the store layout.

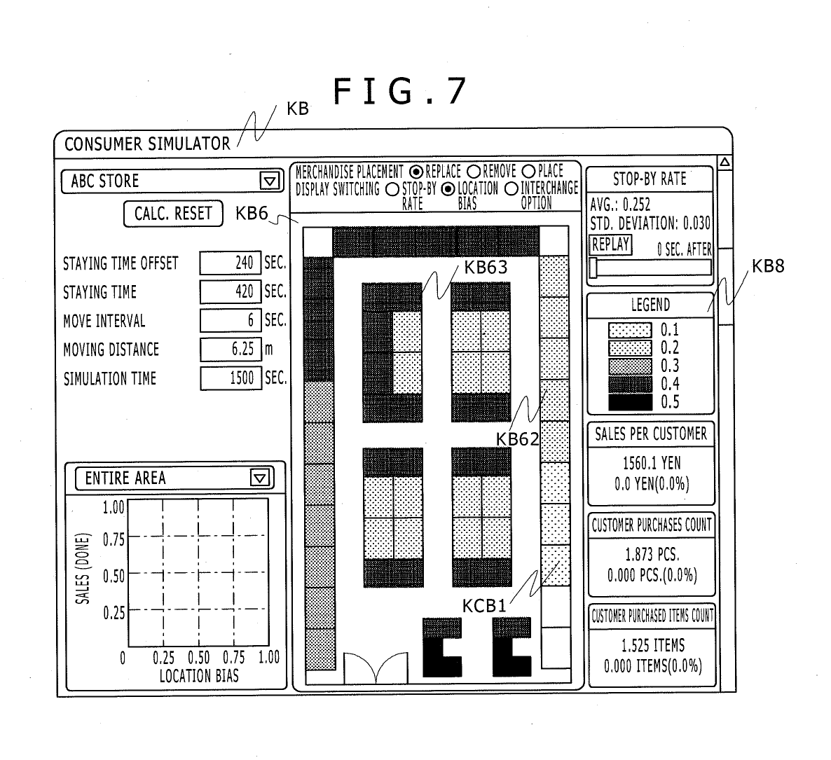

When the user selected the Interchange Option button for stop-by simulation in the KB5 area on the screen of FIG. 7, a screen in FIG. 8 is presented. The screen of FIG. 8 presents a depiction in which, in addition to the location bias which is a locational characteristic, a merchandise effect which is a merchandise item's characteristic is superimposed. KC in FIG. 8 presents an option of interchanging merchandise shelves and characteristics when the shelves have been interchanged. KC4 is a scatter of location bias versus merchandise effect, where nodes KC41 thru KC43 denote shelves and merchandise items placed on the shelves.

In KC, the nodes are marked with different patterns meaning shelves with different levels of merchandise effect and location bias, indicating whether or not each shelf is larger than an average. KC41 is a shelf for which merchandise effect is higher than an average, whereas location bias is lower than an average. KC42 is a shelf for which merchandise effect is lower than an average, whereas location bias is higher than an average. KC43 is a shelf other than the above-mentioned shelves.

In the area KC6, a result of shelves layout evaluation is displayed. The shelves are marked with different patterns meaning different levels of merchandise effect and location bias. KC61 is a shelf for which merchandise effect is higher than an average, whereas location bias is lower than an average. KC62 is a shelf for which merchandise effect is lower than an average, whereas location bias is higher than an average. KC63 is a shelf other than the above-mentioned shelves.

A configuration depicted in FIG. 8 makes it possible to intuitively perceive the shelves (KC61, KC62) for which location bias and merchandise effect are unbalanced and makes it easier to determine merchandise placement. Also, it would be easier to make such a prediction that sales per customer can be increased by interchanging merchandise placed on any of shelves like the shelve KC61 with merchandise placed on any of shelves like the shelve KC62.

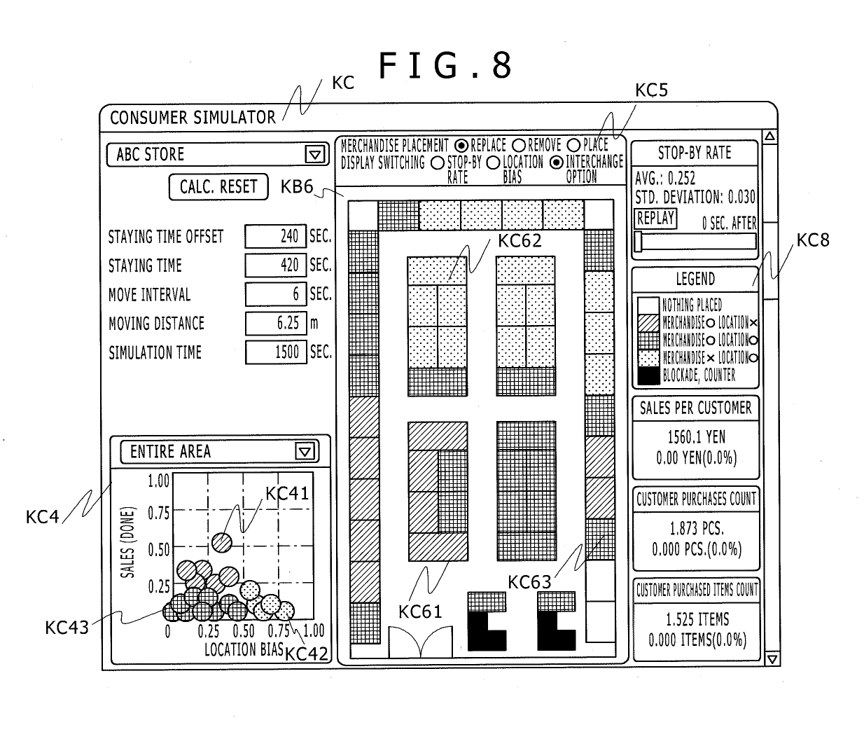

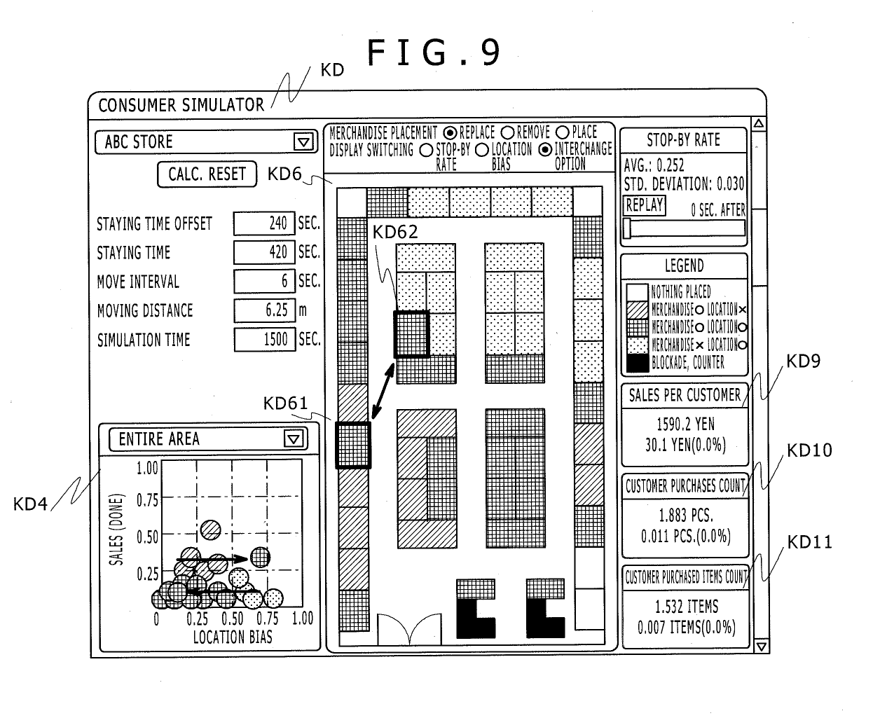

A screen in FIG. 9 presents a result of relocation (interchanging) of merchandise placed on the shelves in the area KC6. The shelves subjected to interchanging are KD61 and KC62. The sales-related values KD9, KD10, KD11 are recalculated after the interchanging and the recalculated values are displayed. Differences from their initial values are also displayed. From a sales model (APD4) which is created through calculation which is illustrated in FIG. 10, a value of sales per customer as will be mentioned below is calculated and its result is displayed in the area KD9. This calculation is executed for all shelves and a total value is calculated with the assignment of location bias of the shelves subjected to change after the interchanging. Here, in a sales model (DP11) in the parameter table (DP), the gradient and intercept in an equation for the sales per customer which is given below are stored.

Sales per customer=B′*a+b

a=Gradient in sales model
b=Intercept in sales model
B′=Location bias of the shelves interchanged

This is exemplary and other calculus equations suitable for the sales model may be used.

In the area KD9, not only the sales per customer, a money amount and a percentage of increase/decrease which is the amount of change in the sales per customer before and after the interchanging are displayed.

In the area KD10, a result of a calculation that substituted the sales per customer KD9 with a customer purchases count is displayed. In the area KD11, a result of a calculation that substituted the sales per customer KD9 with a customer purchased items count is displayed. Detail of both of these calculations is the same as for the sales per customer KD9.

Detail of the calculation will be described later with FIG. 10.

A configuration depicted in FIG. 9 makes it possible for a person in charge of merchandise placement to easily perceive a change made when merchandise locations were interchanged. In an example of FIG. 9, for example, all the values displayed in the areas KD9 thru KD11 increase and it can easily be understood that interchanging the shelves KD61 and KD62 is favorable. Conversely, if these values decrease, it can easily be understood that interchanging the shelves is not favorable.

FIG. 10 is a flowchart of a process of calculation for interchanging merchandise shelves (APD) of the customer simulation (AP) The calculation for interchanging merchandise shelves (APD) predicts sales by processing the merchandise effect which is a merchandise item's characteristic and the location bias which is a characteristic of interchanged shelves (locations) using a sales model.

In a step of input (APD2), the process reads in the files of location bias (APA7) and merchandise effect (APA10). In a step of sales model generation (APD3), the process executes regression based on the input (APD2) data. By generating a sales model, it is made possible to predict sales after rearranging the shelves. A regression equation calculated yields a sales model (APD4). Because an equation for single regression is Y=X*gradient+intercept, gradient and intercept are the parameters determining the sale model (APD4) If another regression calculation is used, necessary parameters may determine the sales model (APD4) as appropriate. This sales model (APD4) is assigned to the sales model (DP11).

FIG. 11 is a flowchart of a store layout evaluation learning (APC) process of the customer simulation (AP). This is learning to obtain a stop-by model (APA8) for executing store layout evaluation (APA)

In a step of input (APC2), the process reads input files necessary for stop-by simulation (APB). In particular, the process reads in the following data: staying time offset (DP5), staying time (DP6), move period (DP7), moving distance (DP8), and simulation time (DP9) stored under the appropriate case ID (DP1) from the parameter table (DP) and the shelf-to-shelf distance table (FD) from the shelves database (F).

In a step of stop-by simulation (APC3), the process executes the simulation using the data obtained in the input (APC2) step, as is the case with FIG. 3. It executes the stop-by simulation (APC3) to calculate a stop-by rate S of the shelves arranged. A stop-by rate S (APC4) is an output result of the stop-by simulation (APC3).

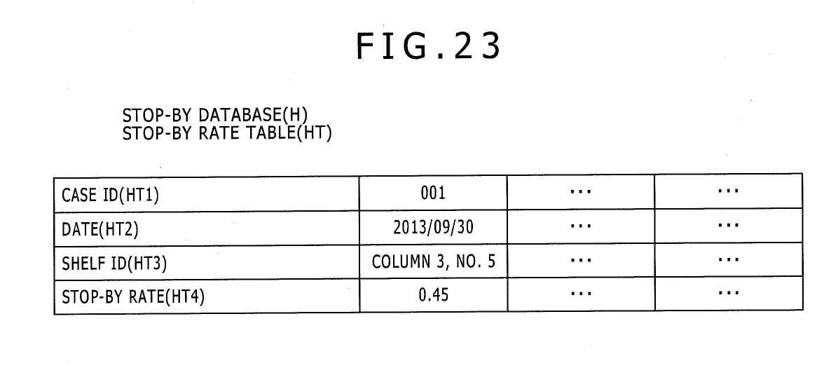

Ina step of stop-by model generation (APC5), the process executes regression based on the stop-by rate S (APC4) and a stop-by rate (APC6). By generating a stop-by model, subsequently, it is made possible to execute store layout evaluation if there is only the stop-by rate S (APC4) which is the result of the stop-by simulation (APC3) without obtaining a stop-by rate (APC6) by an actual survey. The stop-by rate (APC6) will be described with FIG. 23.

A regression equation calculated in the step of stop-by model generation (APC5) yields a stop-by model (APC7). The process assigns this stop-by model to the stop-by model (DP10) and the store layout evaluation learning (APC) process terminates (APC8).

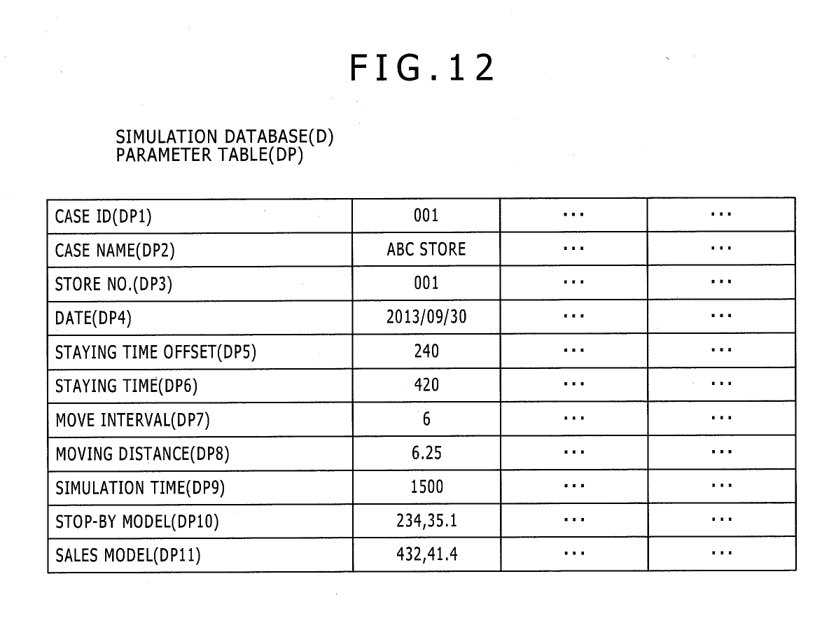

In FIGS. 12 thru 17, tables that are used for simulation are described. These data are stored in the simulation database (D). For the tables described below, if a parameter not mentioned is necessary, it may be added optionally.

FIG. 12 is a parameter table (DP) which stores parameters necessary for the customer simulator (AP).

In FIG. 12, an entry “case ID” (DP1) is ID for identifying a case. An entry “case name” (DP2) is the name of a case. An entry “store No.” (DP3) is a number for identifying a store. An entry “date” (DP4) is a date on which simulation is executed. If simulation is executed over two or more days, the days may be specified. If both date and time are needed, both may be stored (the same applie's to date hereinafter). An entry “staying time offset” (DP5) is a value as such offset assumed when simulation is executed. Value units are seconds. An entry “staying time” (DP6) is customers staying time assumed when simulation is executed and a value in which the customers staying probability becomes 1/e per this time. Value units are seconds.

An entry “move interval” (DP7) is an average interval at which customers move from one shelf to another shelf when simulation is executed. Units are seconds. An entry “moving distance” (DP8) is an average distance of customers moving from one shelf to another shelf when simulation is executed. Units are meters. An entry “simulation time” (DP9) is a time period of simulation execution. Units are seconds.

An entry “stop-by model” (DP10) is a model parameter for use in location bias calculation. A model is comprised of the values of parameters of a fitting function or the equation of the fitting function itself. An entry “sales model” (DP11) is a model parameter for use in location bias calculation. Similarly, a model is comprised of certain values or a certain equation.

FIG. 13 is a state transition probability matrix table (DM) which stores values of the state transition probability indicating a stop-by likelihood of customers stopping by the shelf.

In FIG. 13, an entry “case ID” (DM1) is ID for identifying a case. An entry “date” (DM2) is a date on which simulation is executed. An entry “shelf ID1” (DM3) is a number for identifying shelf 1 and an entry “shelf ID2” (DM4) is a number for identifying shelf 2. Here, if the self ID1 (DM3) and the shelf ID2 (DM4) are in separate cells (which can be located by a row (horizontal) and a column (vertical)), an identifier that can identify the cells may be stored. In an entry “state transition probability” (DM5), a result output by calculating a state transition probability (APB3) in the stop-by simulation (APB) is stored.

FIG. 14 is a table of probability by hopping (DH) which stores values of the probability that customers stop by the shelf at each hopping and for each self. This is also included in the simulation database (D) because of the data for use in simulation. Its contents are described in the following.

In FIG. 14, an entry “case ID” (DH1) is ID for identifying a case. An entry “date” (DH2) is a date on which simulation is executed. An entry “hopping count” (DH3) is the count of hopping repeated. A maximum value of the hopping count is a value calculated by diving the simulation time (DP9) by the move interval (DP7). An entry “shelf ID” (DH4) is a number for identifying a shelf. An entry “probability by hopping” (DH5) is a result of calculating a probability by hopping (APB5) in the stop-by simulation (APB).

FIG. 15 is a stop-by rate S table (DT) for storing stop-by rates per shelf which are a result of simulation.

In FIG. 15, an entry “case ID” (DT1) is ID for identifying a case. An entry “date” (DT2) is a date on which simulation is executed. An entry “shelf ID” (DT3) is a number for identifying a shelf. An entry “stop-by rate S” (DT4) is a result of calculating a probability for cumulative hopping count (APB6) which will be described later in the stop-by simulation.

FIG. 16 is a location bias table (DB) in which location's effect was only quantified from the result of simulation, but merchandise's influence was removed therefrom.

In FIG. 16, an entry “case ID” (DB1) is ID for identifying a case. An entry “date” (DB2) is a date on which simulation is executed. An entry “shelf ID” (DB3) is a number for identifying a shelf. An entry “location bias” (DB4) is a result of a location bias calculation (APA5) in the store layout evaluation (APA).

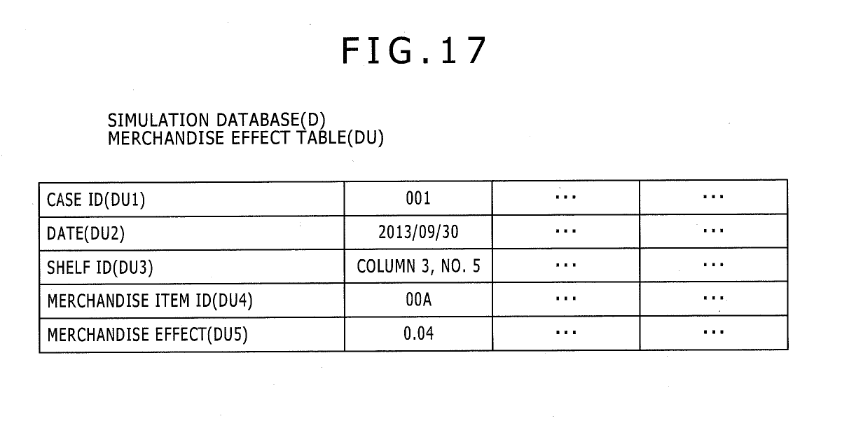

FIG. 17 is a merchandise effect merchandise effect table (DU) in which merchandise effect was quantified from the sales, but location's influence was removed therefrom. In FIG. 17, an entry “case ID” (DU1) is ID for identifying a case. An entry “date” (DU2) is a date on which simulation is executed. An entry “shelf ID” (DU3) is a number for identifying a shelf. An entry “merchandise item ID” (DU4) is a number for identifying a merchandise item. An entry “merchandise effect” (DU5) is a result of a bias calculation (APA8) in the store layout evaluation (APA).

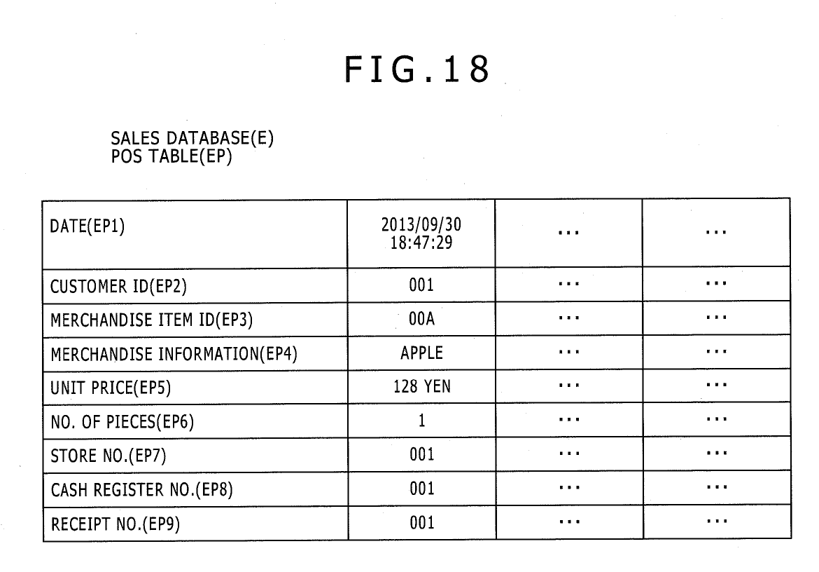

In FIGS. 18 thru 19, tables that are stored in the sales database (E) are described. FIG. 18 is a POS table (EP) in which sales with respect to each customer was quantified. In FIG. 18, an entry “date” (EP1) is a date when a particular merchandise item was registered on a cash register; i.e., the date when a customer purchased it. An entry “customer ID” (EP2) is a number for identifying the customer who purchased it. An entry “merchandise item ID” (EP3) is a number for identifying the merchandise item purchased. An entry “merchandise information” (EP4) is merchandise information relevant to the merchandise item ID (EP3). This information may only indicate particularity of the merchandise item and does not have to be language information such as a bar code. An entry “unit price” (EP5) is a per-piece price of the merchandise item ID (EP3). An entry “number of pieces” (EP6) is the number of pieces purchased of the merchandise item ID (EP3). An entry “store No.” (EP7) is a number for identifying a store. An entry “cash register No.” (EP8) is a number for identifying a cash register in the store No. (EP7). An entry “receipt No.” (EP9) is a number for identifying the purchased merchandise item on a per-account basis at the cash register No. (EP8).

By assigning values as mentioned above, the system can get the number of items sold, the number of purchases, and the sales amount on a per-account basis at the particular cash register. In particular, the system can identify the account for one customer by combining store No. (EP7), cash register No. (EP8), and receipt No. (EP9).

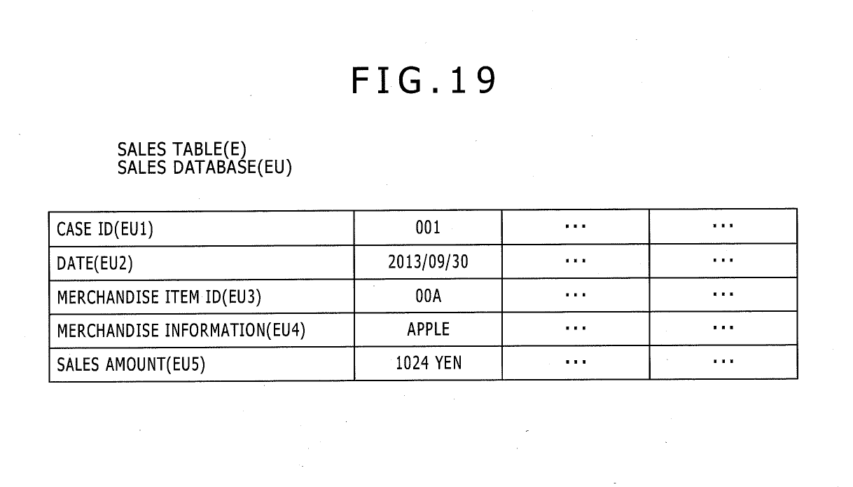

FIG. 19 is a sales table (EU) in which the sales of a merchandise item was specified. This is the sales per merchandise item aggregated from the POS table (EP).

In FIG. 19, an entry “case ID” (EU1) is ID for identifying a case. An entry “date” (EU2) is a date on which simulation is executed; i.e., the date when a customer purchased it. An entry “merchandise item ID” (EU3) is a number for identifying a merchandise item. An entry “merchandise information” (EU4) is merchandise information relevant to the merchandise item ID (EU3). This information may only indicate particularity of the merchandise item and does not have to be language information such as a bar code. An entry “sales amount” (EU5) is the sales amount per merchandise item ID on the date (EU2); that is, the sales per merchandise item on a particular date (EU2), which was aggregated by multiplying the unit price (EP5) by the number of pieces (EP6) in the POS table.

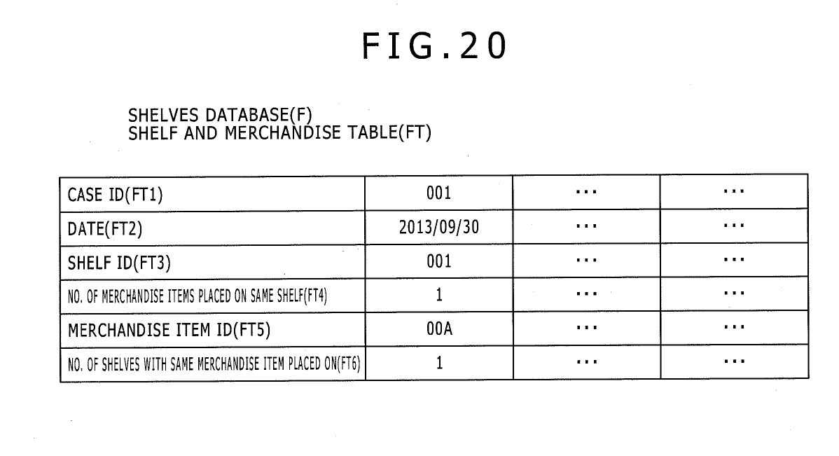

In FIGS. 20 thru 21, tables that are stored in the shelves database (F) are described. FIG. 20 is a shelf and merchandise table (FT) in which association between a merchandise item and a shelf was specified. By using this table, the system gets which merchandise item is placed on which shelf.

In FIG. 20, an entry “case ID” (FT1) is ID for identifying a case. An entry “date” (FT2) is a date on which simulation is executed. An entry “shelf ID” (FT3) is a number for identifying a shelf. If a shelf is in a separate cell (which can be located by a row (horizontal) and a column (vertical)), an identifier that can identify the cell may be stored (the same applies hereinafter). An entry “number of merchandise items placed on same shelf” (FT4) is a number indicating how many merchandise items which are of different types are placed on a shelf. For example, if two types of merchandise items “ice cream” and “frozen food” are dealt on a shelf “A”, this entry is 2. An entry “merchandise item ID” (FT5) is a number for identifying a merchandise item. An entry “number of shelves with same merchandise item placed on” (FT6) is a number indicating the number of shelves on which the merchandise item ID is dealt, if the merchandise item is dealt on a plurality of shelves. For example, if a merchandise item “ice cream” is dealt on shelves “A”, “B”, and “C”, this entry is 3. By holding a value as mentioned above, the system can calculate sales per shelf, when required, by dividing sales by the number of shelves.

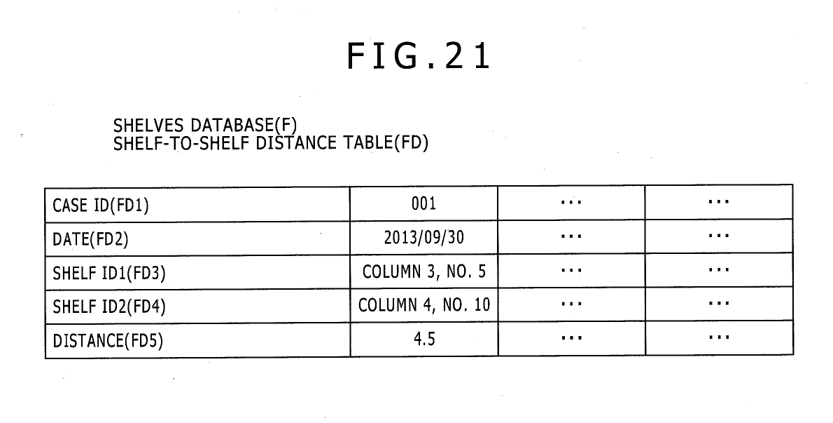

FIG. 21 is a shelf-to-shelf distance table (FD) which stores distance between two shelves taking a blockade into account, in which the IDs of the two shelves are associated with the distance.

In FIG. 21, an entry “case ID” (FD1) is ID for identifying a case. An entry “date” (FD2) is a date on which simulation is executed. An entry “shelf ID1” (FD3) is a number for identifying shelf 1. An entry “shelf ID2” (FD4) is a number for identifying shelf 2. If the self ID1 (FD3) and the shelf ID2 (FD4) are in separate cells (which can be located by a row (horizontal) and a column (vertical)), an identifier that can identify the cells may be stored.

An entry “distance” (FD5) is distance between the self ID1 (FD3) and the shelf ID2 (FD4) taking a blockade into account. Units are meters. To calculate distance, a general algorithm of a shortest path problem such as Dijkstra method, Belman-Ford method, and A*algorithm can be used.

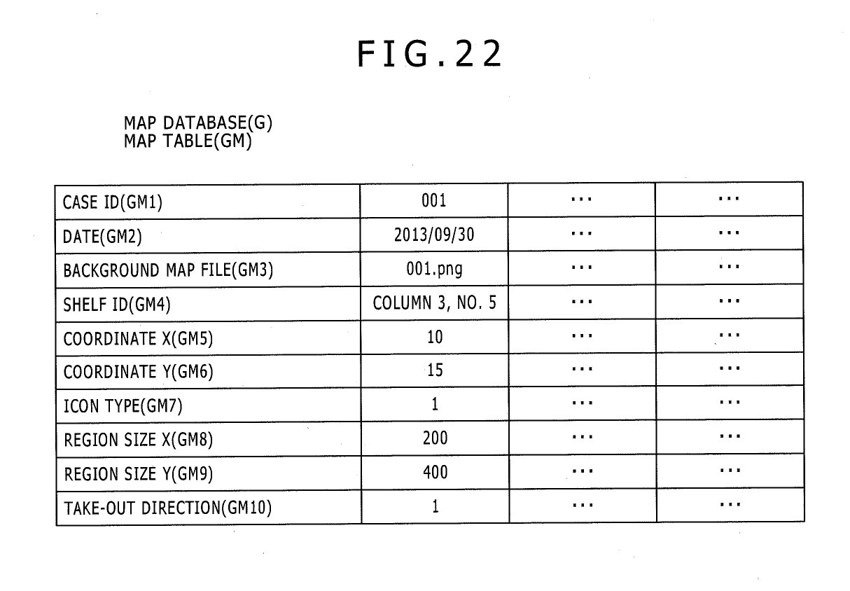

FIG. 22 is a map table (GM) for storing information on icons required to be displayed on the content (K). This is stored in the map database (G).

The content (K) assists input by specifying the icons of shelves, a blockade, etc. on the screen and displaying the icons of these objects helps the user to perceive the objects easily. The map table (GM) is the one in which a correspondence table between an icon in the content (K) and a map is specified.

In FIG. 22, an entry “case ID” (GM1) is ID for identifying a case. An entry “date” (GM2) is a date on which simulation is executed. An entry “background map file” (GM3) is a map file which is displayed in the background of the content (K). An entry “shelf ID” (GM4) is a number for identifying a shelf. An entry “coordinate X” (GM5) is an X-coordinate value for placement viewed from a map base point (origin). An entry “coordinate Y” (GM6) is a Y-coordinate value for placement viewed from the map base point (origin). An entry “icon type” (GM7) is the type of an icon which is displayed. The following values can be assigned: 1 for shelf, 2 for blockade, 3 for initial stop-by, 4 for entrance, 5 for exit, and 6 for counter. If an object has a plurality of functions, a plurality of numbers may be assigned. For example, if there is a doorway, 4 and 5 are assigned. An entry “region size X” (GM8) is a value indicating a dimension in an X-axis direction from the X-coordinate value assigned to the coordinate X (GM5), which is the center when viewed from the map.

An entry “region size Y” (GM9) is a value indicating a dimension in a Y-axis direction from the Y-coordinate value assigned to the coordinate Y (GM6), which is the center when viewed from the map. An entry “take-out direction” (GM10) is a value indicating the direction of a take-out side when viewed from the base point when a shelf was placed. The following values can be assigned: 1 for up, 2 for down, 3 for left, 4 for right.

FIG. 23 is a stop-by rate table (HT) for storing stop-by rates per shelf which were calculated by an actual survey. This is stored in the stop-by database (H).

In FIG. 23, an entry “case ID” (HT1) is ID for identifying a case. An entry “date” (HT2) is a date on which simulation is executed. An entry “shelf ID” (HT3) is a number for identifying a shelf. An entry “stop-by rate” (HT4) is a stop-by rate per shelf calculated by an actual survey. To make a survey, a general measurement method such as questionnaires, laser measurement, and sensors can be used.

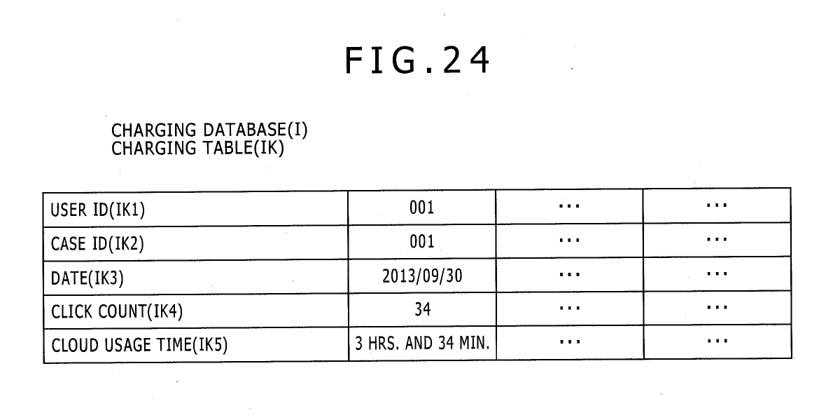

FIG. 24 is data by which a user is charged by recording simulation usage time and count and which is recorded in a charging table (IK). This is stored in the charging database (I). Its contents are described in the following.

In FIG. 24, an entry “user ID” (IKl) is ID for identifying a user (US) who has used the present application. An entry “case ID” (IK2) is ID for identifying a case. An entry “date” (IK3) is a date on which simulation is executed. An entry “click count” (IK4) is the number of times that a query has been transmitted from the client (CL) to the application server (AS). An entry “cloud usage time” (IK5) stores time taken for processing on the application server (AS). If the click count (IK4) and the cloud usage time (IK5) are classified into detail categories, data of usage in detail categories on the basis of per query content and per page may be stored.

From a perspective of the structure of the databases and tables, a feature of the information processing system pertaining to the present embodiment described hereinbefore is described below: the system is characterized by including an input unit (a transmit/receive unit ASS) that takes input of shelves' coordinates information in a store (coordinate X (GM5) and coordinate Y (GM6)), shelf numbers of the shelves (shelf ID (GM4)) and information associating these sets of data (map table (GM), a simulator unit (a customer simulator AP) that executes cycles of a first process that calculates a staying position or staying probability of customers in the store at given time t and a second process that calculates a staying position or staying probability of customers at time (t+Δt), using the shelves' coordinates information, the shelf numbers of the shelves, and information associating these sets of data, thereby calculating a stop-by likelihood of the customers stopping by each of the shelves or a sales prediction per shelf, and a display unit (a display CLID) that displays the stop-by likelihood or sales prediction.

This configuration makes it possible to implement the store layout evaluation content described in the foregoing context and to predict customers' moving lines and stop-by likelihood with the exclusion of the characteristics of merchandise items.

Moreover, by further inputs of shelf numbers (shelf ID (FT3)), information on merchandise items placed on the shelves having the shelf numbers (merchandise item ID (FT5)), and information associating these sets of data (the shelf and merchandise table (FT)) as wells as sales information (sales amount (EU5)), merchandise information (merchandise item ID (EU1)), and information associating these sets of data (the sales table (EU)), it would be made possible to implement the content for optimizing merchandise shelves arrangement, described in the foregoing context, and to predict even an increase/decrease in the sales per customer, customer purchases count, and customer purchased items count due to, for example, changing shelves arrangement.

The invention pertaining to the present embodiment is a system that is applicable to places where people move around and can be applied to factories, construction sites, distribution warehouses, etc. along with stores.

### LIST OF REFERENCE SIGNS

AS Application server
ASS Transmit/receive unit
ASC Control unit
ASCC Communication control
ASCW Web server
AP Customer simulator
APA Store layout evaluation
APB Stop-by simulation
APC Store layout evaluation learning
APD Calculation for interchanging merchandise shelves
APE Charging
ASM Storage unit
D Simulation database
E Sales database
F Shelves database
G Map database
H Stop-by database
I Charging database
CL Client
CLS Transmit/receive unit
CLC Control unit
CLCC Communication control
CLCA Content generation
CLCP Drawing setup
CLCT Analysis condition
CLCW Web browser
CLM Storage unit
CLMP Analysis conditions information
CLMT Drawing setup information
CLI Input/output unit
CLID Display
CLIK Keyboard
CLIM Mouse
CLIU External input/output
K Content
NW Network
US User

1. An information processing system comprising:
an input unit that takes input of first information relevant to a probability of customers staying over time after entering a store, second information indicating shelf-to-shelf distances for a plurality of shelves provided in the store, and third information indicating a staying time during which customers stay in the store and a move interval at which the customers move from shelf to shelf;
a storage unit that stores the first information, the second information, and the third information, and simulation conditions as follows:
a) the customers start to move from the store entrance;
b) there is a high probability that the customers move to a shelf nearer to them than a distant shelf among the plurality of shelves;
c) the customers stay in the store only for the staying time; and
d) the customers randomly move from shelf to shelf,
a simulator unit that calculates probabilities that the customers stay by each of the shelves, using the first information, the second information, the third information, and the simulation conditions; and
a display unit that displays the probabilities associated with the shelves.

2. The information processing system according to claim 1,
wherein the first information is a function that is uniquely determined by two values of an offset of time during which the customers stay in the store and time by which the probability of the customers staying in the store becomes 1/e.

3. The information processing system according to claim 1,
wherein the simulator unit calculates a probability that the customers move from a position at count t (t is a natural number) to a position at count (t+1), where the count is incremented by a move at each of the move interval.

4. The information processing system according to claim 1,
wherein fourth information including sales of the store is further input to the input unit,
the simulator unit calculates, from the sales, merchandise effect which is information with the exclusion of the probabilities, additionally by use of the fourth information and
the display unit displays the probabilities and the merchandise effect.

5. The information processing system according to claim 4,
wherein the simulator unit calculates an average of the probabilities and an average of the merchandise effect, and
the display unit displays each of the shelves marked with patterns that can distinguish two information pieces of whether or not each shelf has the probability larger than an average and whether or not each shelf has the merchandise effect larger than an average.

6. The information processing system according to claim 4,
wherein each of the shelves is configured to be relocatable on the display unit, and
the simulator unit further calculates the probabilities and the merchandise effect when any of the shelves has been relocated.

7. The information processing system according to claim 4,
wherein the simulator unit calculates at least one of sales per customer, customer purchases count, and customer purchased items count of the customers, and
the display unit further displays at least one of the sales per customer, customer purchases count, and customer purchased items count of the customers.

8. An information processing method comprising:
a first step of receiving input of first information relevant to a probability of customers staying over time after entering a store, second information indicating shelf-to-shelf distances for a plurality of shelves provided in the store, and third information indicating a staying time during which customers stay in the store and a move interval at which the customers move from shelf to shelf;
a second step of calculating probabilities that the customers stay by each of the shelves, using the first information, the second information, the third information, and simulation conditions as follows:
a) the customers start to move from the store entrance;
b) there is a high probability that the customers move to a shelf nearer to them than a distant shelf among the plurality of shelves;
c) the customers stay in the store only for the staying time; and
d) the customers randomly move from shelf to shelf, and
a third step of displaying the probabilities associated with the shelves.

9. The information processing method according to claim 8,
wherein the first information is a function that is uniquely determined by two values of an offset of time during which the customers stay in the store and time by which the probability of the customers staying in the store becomes 1/e.

10. The information processing method according to claim 8,
wherein the second step calculates a probability that the customers move from a position at count t (t is a natural number) to a position at count (t+1), where the count is incremented by a move at each of the move interval.

11. The information processing method according to claim 8,
wherein the first step further receives input of forth information including sales of the store,
the second step further calculates, from the sales, merchandise effect which is information with the exclusion of the probabilities, additionally by use of the fourth information and
the third step displays the probabilities and the merchandise effect.

12. The information processing method according to claim 8,
wherein the second step calculates an average of the probabilities and an average of the merchandise effect, and
the third step displays each of the shelves marked with patterns that can distinguish two information pieces of whether or not each shelf has the probability larger than an average and whether or not each shelf has the merchandise effect larger than an average.

13. The information processing method according to claim 8,
wherein the second step further calculates at least one of sales per customer, customer purchases count, and customer purchased items count of the customers, and
the third step further displays at least one of the sales per customer, customer purchases count, and customer purchased items count of the customers.

14. An information processing system comprising:
an input unit that takes input of shelves' coordinates information in a store, shelf numbers of the shelves, and information associating these sets of data;
a simulator unit that executes cycles of a first process that calculates a staying position or staying probability of customers in the store at given time t and a second process that calculates the staying position or staying probability of the customers at time (t+Δt), using the shelves' coordinates information, the shelf numbers of the shelves, and information associating these sets of data, thereby calculating a stop-by likelihood of the customers stopping by each of the shelves or a sales prediction for each of the shelves; and
a display unit that displays the stop-by likelihood or the sales prediction.

15. The information processing system according to claim 14,
wherein the input unit further takes input of the shelf numbers, information on merchandise items placed on the shelves having the shelf numbers, and information associating these sets of data as well as information on the sales, the information on the merchandise items, and information associating these sets of data.
